(19) United States
(12) Patent Application Publication
(10) Pub. No.: US 2013/0339350 A1
(43) Pub. Date: Dec. 19, 2013

(54) Ranking Search Results Based on Click Through Rates

(71) Applicant: Alibaba Group Holding Limited, Grand Cayman (KY)

(72) Inventors: Hui Wei, Hangzhou (CN); Chao Song, Hangzhou (CN); Xiaomei Han, Hangzhou (CN); Chao Chen, Hangzhou (CN); Jiong Feng, Hangzhou (CN)

(21) Appl. No.: 13/919,820

(22) Filed: Jun. 17, 2013

(30) Foreign Application Priority Data
Jun. 18, 2012 (CN) 201210206502.0

(51) Int. Cl. G06F 17/30

(52) U.S. Cl. CPC G06F 17/3053
USPC 707/723

(57) ABSTRACT

The present disclosure provides a search ranking method and apparatus based on a click through rate (CTR) to improve reusability and simplify a ranking process. Before a search ranking, click data of a user within a preset period of time is obtained and a respective weight of each characteristic is determined based on the click data. The search ranking may include the following operations. A query and one or more query targets matching the query are obtained. A respective characteristic of each of the query and the query targets are extracted. With respect to each query target, based on the characteristics of the query and the query targets as well as the respective weight corresponding to each characteristic, a respective CTR is obtained based on one or more models such as a regression model. The query targets are ranked based on their respective CTR and displayed to the user.

### CROSS REFERENCE TO RELATED PATENT APPLICATIONS

This application claims foreign priority to Chinese Patent Application No. 201210206502.0 filed on 18 Jun. 2012, entitled “Method and Apparatus of Ranking Search Results Based on Click Through Rates,” which is hereby incorporated by reference in its entirety.

### TECHNICAL FIELD

The present disclosure relates to the field of searching technology, and more specifically, to a search ranking method and apparatus based on click through rate.

### BACKGROUND

With the continuous development of the Internet, more and more users obtain information via network, and a user can conduct a search by inputting a query to obtain a corresponding search result. Generally, with respect to one or more query targets corresponding to the query, matching degrees between the query and the query targets can be measured according to certain ranking rules and the query targets are ranked based on the matching degrees, and the ranked query targets constitute search results to be displayed to the user, thereby allowing the user to obtain needed results rapidly.

However, such conventional techniques have certain defects. The ranking rules may change according to changes of application scenarios. In other words, if the query targets are different, the corresponding ranking rules will also be different. Consequently, the conventional techniques need a corresponding ranking rule for each application scenario, which has little reusability.

For example, the query targets may be enterprises in an enterprise query. Thus, enterprises matching the query are ranked according to a ranking rule, such as an enterprise size. For another example, in a product query, products matching the query may be ranked according to a price or a launch time. Thus, the reusability of the conventional techniques is very low.

Moreover, if a user requirement changes, the application scenario also changes. The ranking rules are reconfigured when the ranking rules are changed according to the changes of the application scenarios or the user requirement. For example, the user needs different products in winter and summer. Thus, the ranking rule shall be reconfigured and a search ranking method shall be rewritten, which are very cumbersome.

In summary, when the conventional techniques are applied to rank search results, the reusability is low and the method is cumbersome.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a search ranking method and apparatus based on a click through rate (CTR) to improve reusability and simplify a ranking process.

The present disclosure provides the search ranking method based on the CTR. Before a search ranking, click data of a user within a preset period of time is obtained and a respective weight of each characteristic is determined based on the click data.

The search ranking may include the following operations.

A query and one or more query targets matching the query are obtained. A respective characteristic of each of the query and the query targets are extracted. With respect to each query target, based on the characteristics of the query and the query targets as well as a respective weight corresponding to each characteristic, a respective CTR is obtained based on one or more models such as a regression model.

The query targets are ranked based on the respective CTR of each query target and displayed to the user.

For example, after the respective characteristics of the query and the query targets are extracted, there may be the following operation. The respective characteristics of the query and the query targets are quantified into characteristic values.

For example, with respect to each query target, based on the characteristics of the query and the query targets as well as the respective weight corresponding to each characteristic, the respective CTR is obtained based on the regression model by the following operations. The respective weight corresponding to each characteristic is obtained. The respective characteristic value and weight are used to calculate a weighted result for each query target. The weighted result is used in the regression model to predict the respective CTR of the respective query target.

For example, before the search ranking, the click data of the user within the preset period of time may be obtained and the respective weight of each characteristic may be determined based on the click data by the following operations. The click data of the user within the preset period of time is obtained. A respective posterior CTR is calculated based on the click data. The characteristic values of the query and the query targets are obtained. The respective weight of each characteristic is calculated based on the posterior CTR and the characteristic values.

For example, after the click data of the user within the preset period of time for each query target is obtained and before the posterior CTR is calculated based on the click data, there may be an operation wherein abnormal data in the click data is filtered to obtain filtered click data.

For example, the respective posterior CTR may be calculated based on the click data by the following operations. The filtered click data is used for statistics to obtain CTRs of the query targets at each location of a page. The CTRs at each location are used for a weighted calculation to obtain the corresponding posterior CTR.

For example, after the respective characteristic of each of the query and the query targets are extracted, there may be following operations.

With respect to the user who inputs the query, one or more behavior characteristics of the user are extracted. The one or more behavior characteristics of the user may include at least one of the following: click data of the user within the period of time; category data of the user within the period of time; and geography data of the user within the period of time. The category data, for example, may include category data of clicking and/or category data of searching.

The example search ranking method may also further include the following operations. Correlated characteristics of the query, the query targets, and the user are extracted. For example, the query targets may include products, enterprises, or industries.

The present disclosure also provides the search ranking apparatus based on the CTR. The apparatus may include a weight determining module, an obtaining and extracting module, a CTR predicting module, and a ranking and displaying module.

The weight determining module, before a search ranking, obtains click data of a user within a preset period of time and determines a respective weight of each characteristic based on the click data.

The obtaining and extracting module obtains a query and one or more query targets matching the query and a respective characteristic of each of the query and the query targets are extracted.

The CTR predicting module, with respect to each query target, based on the characteristics of the query and the query targets as well as the respective weight corresponding to each characteristic, obtains a respective CTR based on one or more models such as a regression model.

The ranking and displaying module ranks the query targets based on the respective CTR of each query target and displays the ranked query targets to the user.

Compared with the conventional techniques, the present techniques may have the following advantages.

Firstly, in the conventional techniques, the matching degree between the query and each query target is measured according to a certain ranking rule. However, the ranking rules change according to the change of application scenarios. In other words, if the query targets are different, the corresponding ranking rule will also be different. For example, the query targets are companies in a company query, and thus companies matching the query will be ranked only according to a ranking rule, such as a company size. For another example, in a product query, products matching the query may be ranked only according to a price or launch time, and thus the reusability is very low.

However, the present techniques determine the weight of each characteristic by obtaining the click data of the user within the preset period of time before search ranking. When a specific search ranking is executed, regardless of the application scenarios and query targets, corresponding characteristics of the query and query targets are extracted after they are obtained, and the CTRs of the query targets in the search ranking are predicted by one or more models such as the regression model based on the characteristics and weights corresponding to the characteristics.

The present techniques predict the CTRs of various query targets in various application scenarios based on different characteristics of different query targets and weights corresponding to the different characteristics. Thus, the present techniques may be applicable in various application scenarios and have a high reusability.

In addition, in the conventional techniques, when the user requirements change such that the user needs different products in winter and summer, the ranking rules have to be reconfigured and the search ranking method has to be rewritten. The present techniques determine the weight of each characteristic based on the click data within the preset period of time before executing search ranking, and the weight of each characteristic is adjusted with the change of the user requirements at least in quasi-real time without a separate manual configuration. The present techniques apply a simplified method, and thus the CTR of query targets predicted based on the weights will also be adjusted at least in quasi-real time and have high accuracies.

Secondly, the present techniques obtain the click data within the preset period of time and filter the click data, and then obtain the posterior CTR by statistics. The weight of each characteristic is then calculated based on the posterior CTR and the characteristic value of each characteristic. Accordingly, the present techniques update the weight based on the click data. When searching, even with respect to the same query, as the user searches at different time, the corresponding search results may also be different.

Thirdly, the present techniques extract not only characteristics of the query and the query targets but also characteristics of the users such that the weight calculation and the CTR prediction are performed accurately by extracting multi-dimensional characteristics, thereby establishing a reasonable predication model, providing a reasonable guide to users, and reducing disadvantages brought by cheating behaviors. Meanwhile, with respect to the same query, the corresponding search results may be different for different users. Thus, the present techniques also meet individualized needs of the users.

### BRIEF DESCRIPTION OF THE DRAWINGS

To better illustrate embodiments of the present disclosure, the following is a brief introduction of the FIGs to be used in the description of the embodiments. It is apparent that the following FIGs only relate to some embodiments of the present disclosure. A person of ordinary skill in the art can obtain other FIGs according to the FIGs in the present disclosure without creative efforts.

FIG. 1 shows a flow chart of an example search ranking method based on a CTR according to the present disclosure.

FIG. 2 shows a flow chart of an example method for calculating a posterior CTR in the example search ranking method based on the CTR according to the present disclosure.

FIG. 3 shows a flow chart of another example search ranking method based on the CTR according to the present disclosure.

FIG. 4 shows a diagram of an example search ranking apparatus based on the CTR according to the present disclosure.

### DETAILED DESCRIPTION

The following descriptions are described by reference to the FIGs and some example embodiments.

Generally, for search results corresponding to a query, the matching degrees between the query and the search results may be measured according to a certain ranking rule. Then the search results are ranked based on the matching degrees, and the ranked search results are displayed to users, thereby allowing the users to obtain most wanted results rapidly. However, the reusability is lower and the conventional techniques are cumbersome when applying the ranking rule to rank the search results.

The present disclosure provides a search ranking method based on the CTR. The present techniques determine a weight of each characteristic based on click data within a preset period of time before executing a search ranking, and then employ the weight when ranking query targets. Thus, the present techniques adjust the weight in at least quasi-real time based on the click data of the user without reconfiguration. Moreover, the present techniques may predict the CTR by a regression model, and are suitable for various application scenarios and have a high reusability.

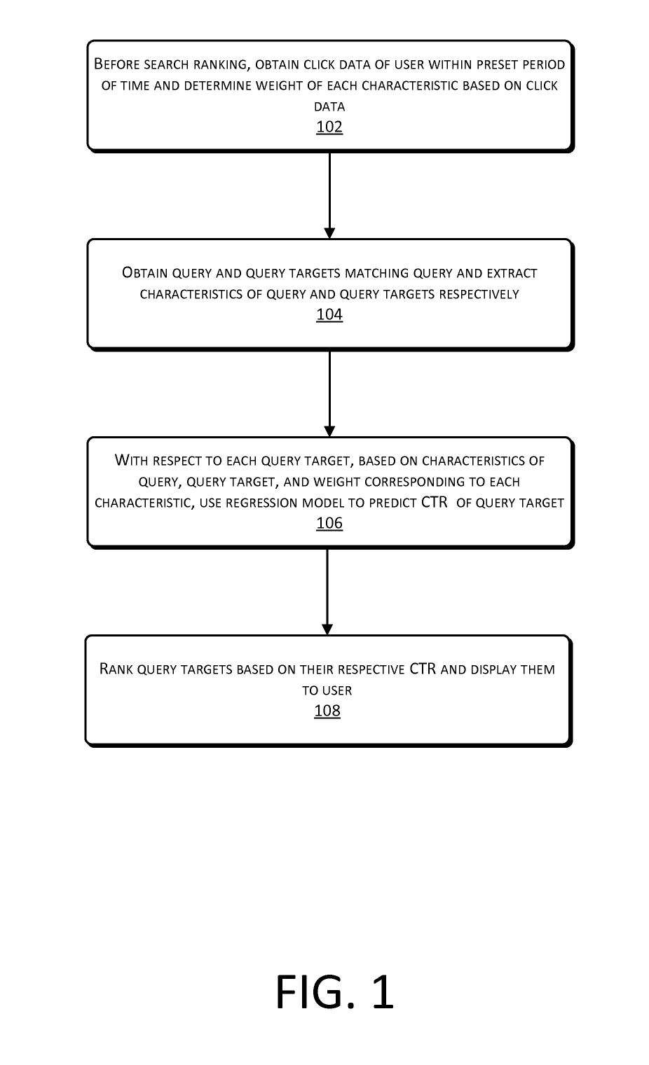

FIG. 1 shows a flow chart of an example search ranking method based on the CTR according to the present disclosure.

At 102, the click data of the user within the preset period of time is obtained before the search ranking and the weight of each characteristic is determined based on the click data.

In the conventional techniques, a change of user requirements will lead to a change of a ranking rule. For example, users need different products in winter and summer, and thus the ranking rule shall be reconfigured and a search ranking method shall be rewritten in different time. Thus, the conventional techniques are very cumbersome.

The click data of the user within the preset period of time is obtained before the search ranking. For example, if the preset period of time is 24 hours, the click data of the user within 24 hours is obtained and the weight of each characteristic is determined based on the click data to prepare for a subsequent prediction of the CTR of the query targets.

In the present techniques, the weight of each characteristic will be adjusted in at least quasi-real time with the change of user requirements without a separate manual configuration and the method is simplified. Thus, the CTR of the query target predicted based on the weight will also be adjusted in at least quasi-real time with a high accuracy rate.

For example, the search ranking may include the following operations.

At 104, the query and one or more query targets matching the query are obtained and characteristics of the query and the query targets are extracted respectively.

First, the query input by the user is obtained, and the query targets matching the query are obtained by a preset matching method. Subsequently, the characteristics of the query and the characteristics of the query targets are extracted. The characteristics may include a keyword of the query and a category of the query. For example, if the query is iPhone, the characteristic of the query is a mobile phone. The present disclosure does not impose any restriction herein.

The characteristics of the query targets are dependent on specific targets. For example, if the query target is a product, the characteristic of the query target may be a category of the product. For another example, if the query target is an enterprise, the characteristic of the query target may be a main product of the enterprise.

At 106, with respect to each query target, based on the characteristics of the query and the query targets as well as a respective weight corresponding to each characteristic, a respective CTR is obtained based on one or more models such as a regression model.

After the query targets matching the query are obtained, with respect to each query target, based on the characteristics of the query and the query targets as well as the respective weight corresponding to each characteristic, the respective CTR is obtained based on the regression model.

The CTR represents a ratio of a number of click times to a number of display times of a respective content at a webpage. The CTR reflects a degree of popularity of the respective content at the webpage. A sum of the number of click times and a number of non-click times is the number of display times.

In the present techniques, different query targets correspond to different characteristics while different characteristics correspond to different weights. However, in the present techniques, no matter the application scenarios and the query targets, the CPR of the query targets in the search ranking may be predicted by the regression model based on the corresponding characteristics of the query and the query targets as well as the weight corresponding to each characteristic. Thus, the present techniques are suitable for various application scenarios and have higher reusability.

At 108, the query targets are ranked based on their respective CTR and displayed to the user.

After the respective CTR of each query target is predicted, the query targets are ranked based on their respective CTR and then the ranked results are displayed to the user.

In the conventional techniques, the respective matching degree of the query and each query target is measured according to a certain ranking rule. However, the ranking rule needs to be changed according to the change of application scenarios. In other words, if the query targets are different, the corresponding ranking rule will also be different. For example, the query targets are companies in a company query, and thus companies matching the query will be ranked only according to a ranking rule, such as a company size. For another example, in a product query, products matching the query may be ranked only according to a price or launch time, and thus the reusability is very low.

However, the present techniques determine weight of each characteristic by obtaining the click data of the user within the preset period of time before the search ranking. When a specific search ranking is executed, regardless of the application scenarios and query targets, corresponding characteristics of the query and query targets are extracted after they are obtained, and the CTRs of the query targets in the search ranking are predicted by one or more models such as the regression model based on the characteristics and weights corresponding to the characteristics.

In the present disclosure, the query targets may include a product, an enterprise, an industry, etc.

At an e-commerce website, when the user conducts a search, the query targets may be product information such as clothes and electronic products sold by a seller at the e-commerce website. The query targets may also be enterprise information of the seller at the e-commerce website. For example, when the query is a mobile phone, the query targets are sellers of the mobile phone. The query targets may also be relevant information of various industries in the e-commerce website.

The present techniques may also be applicable to search ranking of advertisements. A respective weight is determined based on click data of a displayed advertisement. Then advertisement query targets matching the query are obtained when the user searches and their CTRs are predicted based on characteristics and weights. The advertisement query targets are ranked and displayed.

For example, the advertisements may be product information released by the seller that is found during a search at the e-commerce website. The advertisements may also be advertisements of the query targets matching the query and are displayed at an edge of a search result page when the user conducts search. For example, when the user searches pictures of a skirt, skirt related products or sellers of the skirt may be displayed at the edge of the search result page.

For example, characteristics of the query may include a keyword, a category of the query, etc. The query target may also include respective characteristics. For example, if the query target is a product, the corresponding characteristics may include a keyword in a product name, a category, a manufacturing enterprises, etc. If the query target is an enterprise, the corresponding characteristics may include a keyword in an enterprise name, a keyword of a primary product of the enterprise, a primary industry of the enterprise, etc.

The characteristics also may include correlated characteristics of the query and the query targets. Take an enterprise for example, the correlated characteristics may include: whether a category of the query matches the primary industry of the enterprise, a number of keywords in the query that match the enterprise name or a proportion of keywords in the query that match the enterprise name, a number of keywords in the query that match the primary product of the enterprise or a proportion of keywords in the query that match the primary product of the enterprise, etc.

For example, after the characteristics of the query and the query targets are extracted, the example search ranking method may further include the following operations.

The characteristics of the query and the query targets are quantified into characteristic values respectively. For example, after the respective characteristics of the query and the query targets are extracted, the characteristics of the query and the query targets are quantified and the quantified characteristic values are obtained.

With respect to each query target, based on the characteristics of the query and the query targets as well as the respective weight corresponding to each characteristic, the respective CTR is obtained based on the regression model by following operations.

At a first step, the respective weight corresponding to each characteristic is obtained. The weight corresponding to each characteristic may be determined based on the click data before the search ranking. Thus, the weight corresponding to each characteristic may be obtained prior to the prediction of the CTR.

At a second step, the respective characteristic value and weight are used to calculate a weighted result for each query target. The characteristic value of each characteristic and the weight corresponding to each characteristic is obtained for each query target. Thus, the characteristic values and their respective weights may be used for weighted operations.

At a third step, the weighted result is used in the regression model to predict the respective CTR of the respective query target.

The weighted result is substituted into the regression model and then the CTR of the query targets is predicted.

For example, the CTR may be fitted using a logistic regression model, wherein f(z) represents a predicted CTR, x₁, . . . , xₖ represent a characteristic values of a k-th characteristic, ω₀, . . . , ωₖ represent a weight of the k-th characteristics. An example formula is as follows:

$$f ( z ) = \frac{{e}^{z}}{{e}^{z} + 1} = \frac{1}{1 + {e}^{- z}}$$

$$where$$

$$z = {ω}_{0} + {ω}_{1} {x}_{1} + {ω}_{2} {x}_{2} + {ω}_{3} {x}_{3} + … + {ω}_{k} {x}_{k}$$

For example, before the search ranking, the click data of the user within the preset period of time is obtained and the weight of each characteristic is determined based on the click data by the following operations.

At a first step, the click data of the user within the preset period of time is obtained and a posterior CTR is calculated based on the click data.

The click data of the user within the preset period of time is obtained. For example, if the preset period of time is 24 hours, the click data of the user within 24 hours is obtained. Subsequently, the click data is used for statistics and a posterior CTR is obtained through the statistics.

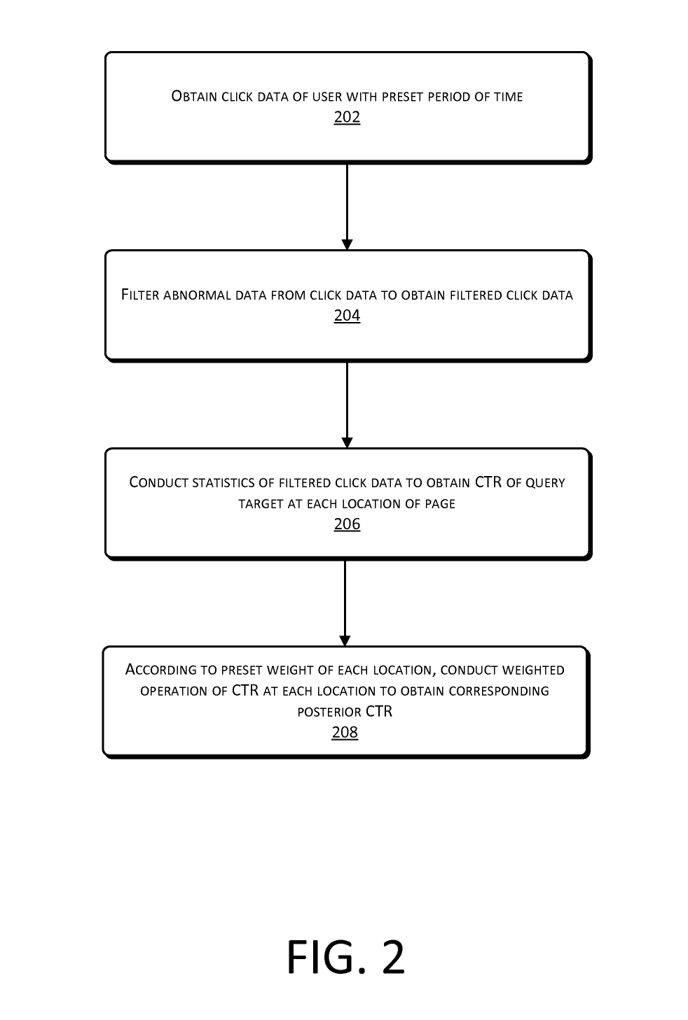

FIG. 2 shows a flow chart of an example method for calculating the posterior CTR in an example search ranking method based on the CTR according to the present disclosure.

At 202, the click data of the user within the preset period of time is obtained.

For example, after the click data of the user within the preset period of time for each query target is obtained and before the posterior CTR is calculated based on the click data, the example method for calculating the posterior CTR may also include the following operation.

At 204, abnormal data in the click data is filtered to obtain filtered click data.

After the click data of the user within the preset period of time is obtained and before the posterior CTR is calculated based on the click data, the abnormal data in the click data is filtered to obtain the filtered click data.

In practical processing, there may be different flow volume cheating and click cheating at various websites. Click data from the cheating is treated as the abnormal data. For example, some users continuously search a respective query target by using some cheating tools such that the respective query target obtains a high CTR. Accordingly, the abnormal data such as the click data from the cheating shall be filtered to obtain the filtered click data.

For example, the calculation of the posterior CTR based on the click data may include the following operations.

At 206, the filtered click data are used for statistics to obtain the CTR of the query target at each location of a page.

For example, there may be many locations for the query target in a real application scenario. Thus, with respect to the click data obtained within the preset period of time for each query target, the click data may include clicks of the query target at different locations. For instance, the query target may be displayed 100 times and clicked 5 times at a first location, and displayed 50 times and clicked 3 times at a third location.

Accordingly, the filtered click data is used for statistics to obtain the CTR of the query target at each location at the page. In the above example, the query target has a CTR of 0.05 at the first location and a CTR of 0.06 at the third location at the page.

At 208, according to a preset weight of each location, the CTR at each location is weighted to obtain the corresponding posterior CTR.

The query target may be displayed at different locations at the page, which may affect the CTR of the query target. For example, the query target displayed at the first location is generally most easily seen by the user and most easily clicked by the user. Consequently, the present techniques may preset the respective weight for each location, and conduct a weighted operation by using the above obtained CTR at each location and the respective weight for each location to obtain the posterior CTR of the query target.

For example, the weight for each location may be determined by normalizing to the weight for the first location. For instance, the weight for the first location is 1, the weight for the second location is 1.5, the weight for the third location is 2, etc. Accordingly, in the above example, the posterior CTR of the query targets is 0.05×1+0.06×2=0.17.

At a second step, a respective characteristic value of the query and the query targets is obtained.

For example, the characteristic values x₁, . . . , xₙ of the query and the query targets may be extracted.

At a third step, the weight of each characteristic is calculated based on the posterior CTR and their respective characteristic value.

Based on the posterior CTR and the characteristic value, the weight of each characteristic is obtained. For example, the weight of each characteristic may be calculated by a least square method as follows.

$$\begin{matrix}{min}_{w} f ( w ) = {\sum }_{i = 1}^{n} {( f ( {z}_{i} ) - {ectr}_{i} )}^{2} + C \cdot L ( w ) \\ = {\sum }_{i = 1}^{n} {( \frac{1}{1 + {e}^{- {ω}_{0} - {\sum }_{j = 1}^{j = m} {ω}_{j} {x}_{j}}} - {ectr}_{i} )}^{2} + C {\sum }_{i = 1}^{m} {ω}_{i}^{2}\end{matrix}$$

In the equation, n represents a number of training samples; m represents a number of characteristics; C represents a coefficient of a penalty term and the penalty term is used for defining a scale of the model; ectr represents a posterior CTR of each training sample, which is obtained by statistics of historical exposure click data, wherein ectr=click times/exposure times.

In the equation, samples are labeled i, characteristics are labeled j, ωⱼ is the weight of the j-th characteristic and xⱼ is the value of the j-th characteristic.

The present techniques obtain the click data within the preset period of time and filter the click data, and then obtain the posterior CTR by statistics. The weight of each characteristic is then calculated based on the posterior CTR and the characteristic value of each characteristic. Accordingly, the present techniques update the weight based on the click data. When searching, users may have different searching time for the same query and thus may have different corresponding search results.

After the characteristics of the query and the query targets are extracted respectively, the present techniques may also include the following operations.

With respect to the user that inputs the query, one or more behavior characteristics of the user are extracted. The behavior characteristics of the user may include at least one of the following:

(1) Click Data of the User Within a Period of Time

That is, a historical CTR of the user is obtained. The CTR is directly calculated from historical data of the user.

For example, when applied to the CTR of advertisements, this characteristic may measure whether a buyer likes clicking the advertisements. Thus, with respect to the buyer who likes clicking the advertisements, some more advertisements may be displayed to meet user requirement. However, with respect to a buyer who dislikes clicking the advertisements, advertisements may be displayed as few as possible to improve user search experiences.

(2) Category Data of the User Within the Period of Time

The category data may include clicked category data and/or searched category data. For example, there may be two approaches to mine the category data of the user.

\textcircled{1} Category Data Searched by the User

One or more queries that are searched by the user within the period of time are obtained from a log such as a search log by statistics. The queries are mapped to categories to obtain a category distribution of the user's searching. Top n categories may be used as characteristics of searched category data of the user, wherein n may be any positive integer.

\textcircled{2} Category Data Clicked by the User

One or more query targets that are clicked by the user within the period of time are obtained from the log by statistics. For example, a distribution of primary business categories of enterprises, as an example of the query targets, may be obtained to obtain a category distribution clicked by the user. Top m categories may be used as characteristics of clicked category data of the user, wherein m may be any positive integer.

The category data searched by the user and the category data clicked by the user may be combined to obtain the category data of the user. For example, the redundant data from the category data searched by the user and the category data clicked by the user may be removed.

(3) Geography Data of the User Within the Period of Time

There may be two approaches to mine the geography data of the user.

\textcircled{1} Clicked Geography Areas

A geography distribution of query targets that are clicked by the user within the period of time is obtained by statistics from the log. Geography areas are ranked based on their occurrence frequencies, and top p geography areas are used as the areas preferred by the buyer.

\textcircled{2} Located Geography Areas

For example, an IP address recorded in the log is obtained and the IP address is mapped to a specific area. Thus, geography data such as a city and a state that the user locates is obtained.

As discussed above, the correlated characteristics of the query and the query targets may be extracted. Thus, for example, the correlated characteristics of the query, the query targets, and the user may be extracted.

The correlated characteristics may include whether the geography area where the user is located matches the query targets, whether the category data of the user matches category of the query target, etc.

The present techniques extract not only characteristics of the query and the query targets but also characteristics of users. The weight calculation and CTR prediction are performed more accurately by extracting multi-dimensional characteristics, thereby establishing a more reasonable predication model, providing a more reasonable guidance to users, and reducing disadvantages brought by cheating behaviors. Meanwhile, there may be different search results for different users even for the same query, thereby meeting individualized needs of the users.

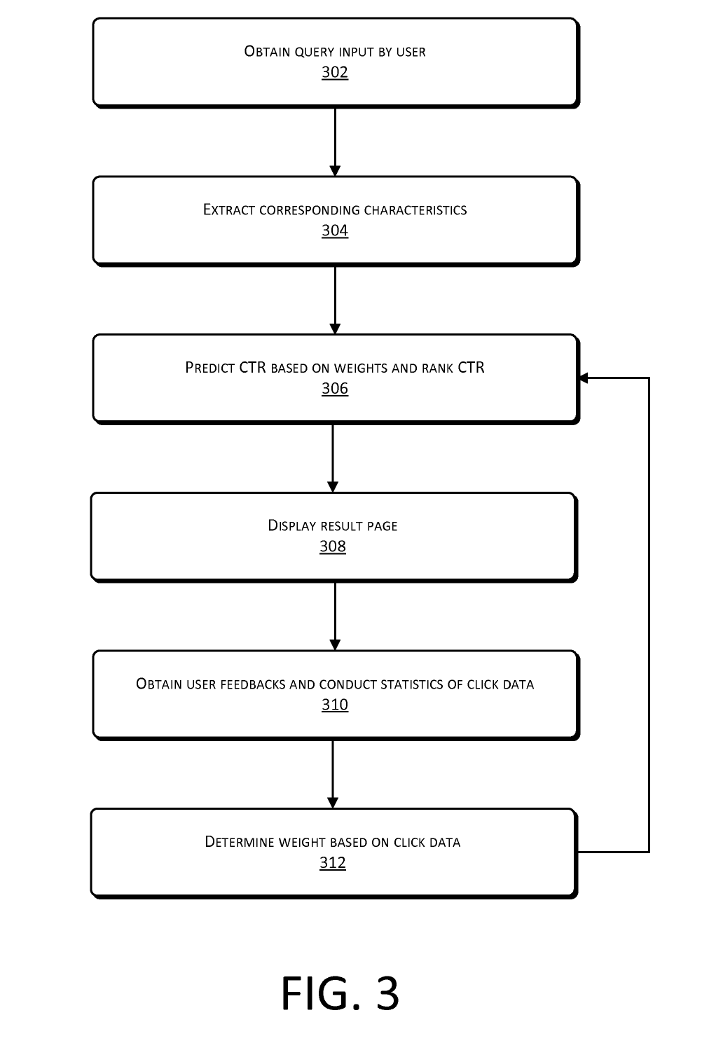

FIG. 3 shows a flow chart of another example search ranking method based on a CTR according to the present disclosure.

At 302, a query inputted by a user is obtained. At 304, one or more corresponding characteristics are extracted. The characteristics may include characteristics of the query, characteristics of query targets, characteristics of the user, etc. At 306, the CTR is predicted based on the weight and ranked. At 308, a search result page is displayed to the user. At 310, user feedbacks are obtained and click data is obtained for statistics. At 312, the weight is determined based on the click data, which is subsequently substituted into operations at 306 to predict the CTR.

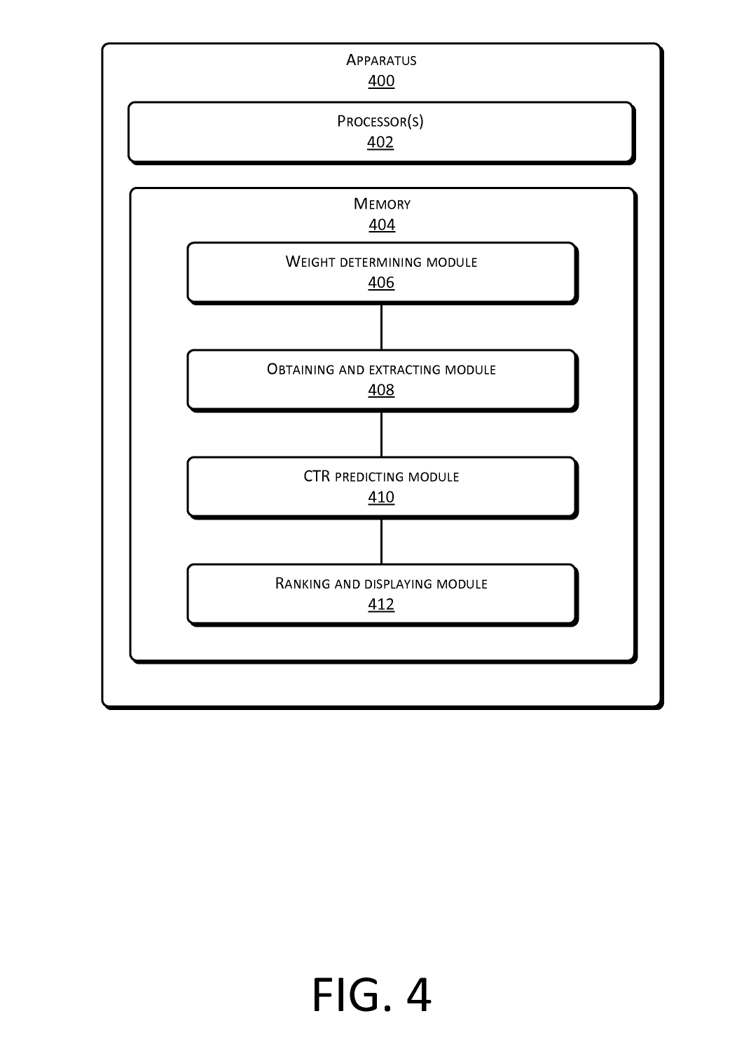

FIG. 4 shows a diagram of an example search ranking apparatus 400 based on a CTR according to the present disclosure.

The apparatus 400 based on the CTR may include one or more processor(s) 402 and memory 404. The memory 404 is an example of computer-readable media. As used herein, “computer-readable media” includes computer storage media and communication media.

Computer storage media includes volatile and non-volatile, removable and non-removable media implemented in any method or technology for storage of information such as computer-executable instructions, data structures, program modules, or other data. In contrast, communication media may embody computer-readable instructions, data structures, program modules, or other data in a modulated data signal, such as a carrier wave. As defined herein, computer storage media does not include communication media. The memory 404 may store therein program units or modules and program data.

In the example of FIG. 4, the memory 404 may store therein a weight determining module 406, an obtaining and extracting module 408, a CTR predicting module 410, and a ranking and displaying module 412.

The weight determining module 406, before a search ranking, obtains click data of a user within a preset period of time and determines a respective weight of each characteristic based on the click data.

The search ranking may be performed by the following modules and operations.

The obtaining and extracting module 408 obtains a query and one or more query targets matching the query and extracts a respective characteristic of each of the query and the query targets.

The CTR predicting module 410, with respect to each query target, based on the characteristics of the query and the query targets as well as the respective weight corresponding to each characteristic, obtains a respective CTR based on one or more models such as a regression model.

The ranking and displaying module 412 ranks the query targets based on the respective CTR of each query target and displays the ranked query targets to the user.

For example, the weight determining module 406 may also quantify the characteristics of the query and the query targets into characteristic values respectively.

For example, the CTR predicting module 410 may also include an obtaining sub-module, a weighting sub-module, and a predicting sub-module. The obtaining sub-module obtains the weight corresponding to each characteristic. The weighting sub-module conducts weighting operation based on the characteristic value and the weight to obtain a weighted result for each query target. The predicting sub-module substitutes the weighted result into the regression model and predicts the CTR of the query target.

For example, the weight determining module 406 may also include a first obtaining sub-module, a second obtaining sub-module, and a weighted calculating sub-module. The first obtaining sub-module obtains the click data of the user within the preset period of time and calculates a posterior CTR based on the click data.

The second acquisition sub-module obtains characteristic values of the query and the query targets. The weighted calculating sub-module calculates a weight of each characteristic based on the posterior CTR and the characteristic value.

For example, the first obtaining sub-module may further include a filtering unit, a statistics unit, and a post CTR determining unit. The filtering unit filters abnormal data from the click data to obtain filtered click data. The statistics unit conducts statistics of the filtered click data to obtain the CTR of the query target at each location of a page. The posterior CTR determining unit conducts a weighted operation of the CTR at each location based on a preset weight of each location to obtain the corresponding posterior CTR.

For example, the apparatus 400 may further include a behavior characteristic extracting module and a correlated characteristic extracting module. The behavior characteristics extracting module extracts one or more behavior characteristics of the user that inputs the query. The behavior characteristics of the user may include at least one of the following: click data of the user within a period of time and category data of the user within the period of time. The category data may include clicked category data, searched category data, and/or geography data of the user within the period of time.

The correlated characteristics extracting module extracts correlated characteristics of the query, the query targets, and the user. For example, the query targets may include products, enterprises, industries, etc.

The present techniques in the example apparatus embodiments are similar to those in the example method embodiments, and thus described in brevity. The relevant portions in the example apparatus embodiments may be referenced to the corresponding portions in the example method embodiments.

Various embodiments of the present disclosure are described in a progressive way and each of the embodiments focuses on differences from other embodiments so that same or similar portions among various embodiments may be referred to each other.

The present disclosure may be described in the general context of a computer-executable instruction, for example, a program module, that is executed by a computer including one or more processors. Generally, the program module includes a routine, a program, an object, an assembly, a data structure and the like that execute a particular task or realize a particular abstract data type. The present disclosure can also be implemented in a distributed computing environment. In the distributed computing environment, tasks are executed by one or more remote processing devices connected via a communication network. In the distributed computing environment, the program module may be stored in local and remote computer storage media including storage devices.

One of ordinary skill in the art should understand that the embodiments of the present disclosure can be methods, systems, or the programming products of computers. Therefore, the present disclosure can be implemented by hardware, software, or in combination of both. In addition, the present disclosure can be in a form of one or more computer programs containing the computer-executable codes which can be implemented in the computer-executable storage medium (including but not limited to disks, CD-ROM, optical disks, etc.).

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

It is noted that any relational terms such as “first” and “second” in this document are only meant to distinguish one entity from another entity or one operation from another operation, but not necessarily request or imply existence of any real-world relationship or ordering between these entities or operations. Moreover, it is intended that terms such as “include”, “have” or any other variants mean non-exclusively “comprising”. Therefore, processes, methods, articles or devices which individually include a collection of features may not only be including those features, but may also include other features that are not listed, or any inherent features of these processes, methods, articles or devices. Without any further limitation, a feature defined within the phrase “include a . . . ” does not exclude the possibility that process, method, article or device that recites the feature may have other equivalent features.

The above descriptions of the example embodiments illustrate example search ranking methods and apparatuses based on the CTR. The example embodiments illustrate the principles and their implementations in accordance with the present disclosure. The embodiments are merely for illustrating the methods and core concepts of the present disclosure and are not intended to limit the scope of the present disclosure. It should be understood by one of ordinary skill in the art that certain modifications, replacements, and improvements can be made and should be considered under the protection of the present disclosure without departing from the principles of the present disclosure. The descriptions herein shall not be understood to restrict the present disclosure.

What is claimed is:

1. A method comprising:
obtaining click data of a user within a preset period of time and determining a respective weight of a respective characteristic based on the click data;
obtaining a query and one or more query targets matching the query;
extracting one or more characteristics from the query and a respective query target of the one or more targets; and
with respect to the respective query target, based on the one or more characteristics of the query and the respective query target and the respective weight corresponding to the respective characteristic, calculating a click through rate (CTR) of the respective query target.

2. The method as recited in claim 1, further comprising ranking the one or more query targets based on their respective CTR.

3. The method as recited in claim 2, further comprising displaying the ranked one or more query targets to the user.

4. The method as recited in claim 1, wherein the calculating the CTR of the respective query target comprises using a regression model to predict the CTR.

5. The method as recited in claim 1, further comprising after extracting the characteristics from the query and the respective query target, quantifying the respective characteristic into a respective characteristic value.

6. The method as recited in claim 5, wherein the calculating the CTR of the respective query target comprises:
obtaining the respective weight of the respective characteristic;
with respect to the respective query target, conducting a weighted operation based on the respective characteristic value and the respective weight of the respective characteristic to obtain a weighted result; and
substituting the weighted result into a regression model to predict the CTR of the respective query target.

7. The method as recited in claim 6, wherein the obtaining click data of the user within the preset period of time and determining the respective weight of the respective characteristic based on the click data comprises:
obtaining the click data of the user within the preset period of time;
calculating a posterior CTR based on the click data;
obtaining characteristic values of the query and the query target; and
based on the posterior CTR and the characteristic values, calculating the respective weight of the respective characteristic.

8. The method as recited in claim 7, further comprising:
after obtaining the click data of the user within the preset period of time and before calculating the posterior CTR based on the click data, filtering abnormal data from the click data to obtain filtered click data.

9. The method as recited in claim 8, wherein the calculating the posterior CTR based on the click data comprises:
conducting statistics of the filtered click data to obtain a CTR of the query target at each location at a page; and
according to a preset weight of a respective location, conducting a weighted operation of the CTR at each location to obtain the corresponding posterior CTR.

10. The method as recited in claim 1, further comprising:
with respect to the user that inputs the query, extracting one or more behavior characteristics of the user.

11. The method as recited in claim 10, wherein the one or more characteristics of the user comprises at least one of the following:
click data of the user within the preset period of time;
category data of the user within the preset period of time; and
geography data of the user within the preset period of time.

12. The method as recited in claim 11, wherein the category data includes category data searched by the user within the preset period of time.

13. The method as recited in claim 1, wherein the category data includes category data clicked by the user within the preset period of time.

14. The method as recited in claim 1, further comprising:
extracting one or more correlated characteristics of the query, the respective query target, and the user to determine that a characteristic of the user matches a characteristic of the query or the respective query target.

15. The method as recited in claim 14, wherein the extracting one or more correlated characteristics of the query, the query target, and the user comprises:
determining a geography area that the user is located or a preferred geography area of the user; and
determining whether the geography area that the user locates or the preferred geography area of the user matches the query target.

16. The method as recited in claim 1, wherein the respective query target includes a product, an enterprise, or an industry.

17. A method comprising:
obtaining click data of a user within a preset period of time;
calculating a posterior click through rate (CTR) based on the click data;
obtaining characteristic values of a query and a query target;
calculating a weight of a respective characteristic based on the posterior CTR and the characteristic values.

18. The method as recited in claim 17, wherein the calculating the posterior CTR based on the click data comprises:
filtering abnormal data from the click data to obtain filtered click data;
conducting statistics of the filtered data to obtain a respective CTR of the query target at a respective location of a page;
conducting a weighted operation based on a respective preset weight of the respective location and the respective CTR of the query target at the respective location to obtain the posterior CTR.

19. The method as recited in claim 17, wherein the calculating the weight of the respective characteristic based on the posterior CTR and the characteristic values comprises using a least square method.

20. An apparatus comprising:
a weight determining module that obtains click data of a user within a preset period of time and determines a respective weight of each characteristic based on the click data;
an obtaining and extracting module that obtains a query and one or more query targets matching the query and extracts a respective characteristic of each of the query and the query targets;
a click through rate (CTR) predicting module that, with respect to each query target, based on the characteristics of the query and the query targets as well as the respective weight corresponding to each characteristic, obtains a respective CTR based on one or more models including a regression model; and
a ranking and displaying module that ranks the query targets based on the respective CTR of each query target and displays the ranked query targets to the user.
